(19) United States
(12) Patent Application Publication
(10) Pub. No.: US 2018/0057683 A1
(43) Pub. Date: Mar. 1, 2018

(54) COVER FOR A TABLET OR A MOBILE PHONE OR A LAPTOP BOTTOM AND A WATCH STRAP CONSISTING AT LEAST PARTLY OF A POLYMER COMPOSITION

(71) Applicant: DSM IP ASSETS B.V., Heerlen (NL)

(72) Inventors: Angelika SCHMIDT, Echt (NL); Lan WEI, Echt (NL)

(21) Appl. No.: 15/559,879

(22) PCT Filed: Mar. 8, 2016
(86) PCT No.: PCT/EP2016/054944

§ 371 Date: Sep. 20, 2017

(30) Foreign Application Priority Data
Mar. 26, 2015 (EP) 15161118.3
Aug. 17, 2015 (EP) 15181264.1

(51) Int. Cl. C08L 65/00; G06F 1/16; A44C 5/00; H04B 1/3888; H04B 1/3827; H04M 1/02

(52) U.S. Cl. CPC C08L 65/00; G06F 1/1616; A44C 5/0053; C08L 2205/03; H04B 1/385; H04M 1/0283; H04B 1/3888

(57) ABSTRACT

A cover for a tablet, a mobile phone or a laptop bottom and a watch strap, consisting at least partly of a polymer composition containing: (A) a thermoplastic elastomer, and (B) 1-30 wt. % of an epoxydized plasticizer.

The invention relates to a cover for a tablet, a mobile phone or a laptop bottom and a watch strap, consisting at least partly of a polymer composition.

A problem of a cover for a tablet, a mobile phone or a laptop bottom and a watch strap is that they come in contact with the skin of their users. Because of that they become filthy under the influence of sebum that is transferred from the skin to the surface of the shaped article during the contact. Because of the presence of the sebum on the cover or watch strap even further dirt is attracted and the cover or the watch strap get an unattractive appearance. Also the mechanical properties of the polymer composition are negatively influenced by the sebum swelling the polymer composition. It is important that the polymer composition has a low hardness and that it is flexible. A problem however is that by lowering the hardness and increasing the flexibility, the uptake of sebum increases as well.

Object of the invention is to provide such a cover for a tablet, a mobile phone or a laptop bottom and a watch strap that show a reduced tendency to attract sebum, so that the good appearance of the article is maintained for a longer period. Surprisingly this object is obtained if the polymer composition of the shaped object according to present invention contains:
(A) a thermoplastic elastomer, and
(B) 1-30 wt. % of an epoxydized plasticizer.

The cover for a tablet, a mobile phone or a laptop bottom and the watch strap show a reduced tendency to attract sebum. This while having a low hardness and being very flexible.

### Thermoplastic Elastomer

As the thermoplastic elastomer a thermoplastic elastomer is used that is chosen out of the group of a thermoplastic copolyester elastomer, a thermoplastic copolyamide elastomer and a thermoplastic polyurethane elastomer. It is possible that the composition contains two or even three thermoplastic elastomers chosen form the group above. Preferably however the composition contains only one thermoplastic elastomer chosen from the group above.

Thermoplastic polyurethane elastomers may be obtained by the condensation of diisocyanates with short-chain diols and long chain diols, for example polyester or polyether diols. The polymer chain segments comprising the monomeric units of the diisocyanates and the short-chain diols are the crystalline hard segments and the chain segments derived from the long chain diols are the soft segments. The diisocyanate most commonly used is 4,4′-diphenylmethane diisocyante (MDI). Commonly used short-chain diols include ethylene glycol, 1,4-butanediol, 1,6-hexanediol and 1,4-di-β-hydroxyethoxybenzene.

The copolyester elastomers and copolyamide elastomers are thermoplastic polymers with elastomeric properties comprising polyester hard segments or polyamide hard segments, and soft segments derived from another polymer. The polyester hard segments in the copolyester elastomers are generally composed of monomer units derived from at least one alkylene diol and at least one aromatic or cycloaliphatic dicarboxylic acid. The polyamide hard segments of the copolyamide elastomers are generally composed of monomer units from at least one aromatic and/or aliphatic diamine and at least one aromatic or aliphatic dicarboxylic acid, and or an aliphatic amino-carboxylic acid.

The hard segments typically consist of a polyester or polyamide having a melting temperature or glass temperature, where applicable, well above room temperature, and may be as high as 300° C. or even higher. Preferably the melting temperature or glass temperature is at least 150° C., more preferably at least 170° C. or even at least 190° C. Still more preferably the melting temperature or glass temperature of the hard segments is in the range of 200-280° C., ort even 220-250° C. The soft segments typically consist of segments of an amorphous polymer having a glass transition temperature well below room temperature. Preferably the glass temperature of the amorphous polymer is at most 0° C., more preferably at most −10° C. or even at most −20° C. Still more preferably the glass temperature of the soft segments is in the range of −20-−50° C., or even −30-−60° C.

Suitably, the copolyamide elastomer is a copolyetheramide elastomer. Copolyetheramide elastomers are available, for example, under the trade name PEBAX, from Elf Atochem, France.

Preferably, the thermoplastic elastomer is a copolyester elastomer. Examples of copolyester elastomers include a copolyesterester elastomer, a copolycarbonateester elastomer or a copolyetherester elastomer; i.e. a copolyester block copolymer with soft segments derived from a polyester, a polycarbonate or, respectively, a polyether. Copolyester elastomers are available, for example, under the trade name Arnitel, from DSM Engineering Plastics B.V. The Netherlands.

Suitable copolyesterester elastomers are described, for example, in EP-0102115-B1.

Copolyetherester elastomers have soft segments derived from at least one polyalkylene oxide glycol. Copolyetherester elastomers and the preparation and properties thereof are in the art and for example described in detail in Thermoplastic Elastomers, 2nd Ed., Chapter 8, Carl HanserVerlag (1996) ISBN 1-56990-205-4, Handbook of Thermoplastics, Ed. O. Otabisi, Chapter 17, Marcel Dekker Inc., New York 1997, ISBN 0-8247-9797-3, and the Encyclopedia of Polymer Science and Engineering, Vol. 12, pp. 75-117 (1988), John Wiley and Sons, and the references mentioned therein.

The aromatic dicarboxylic acid in the hard segments of the polyetherester elastomer suitably is selected from the group consisting of terephthalic acid, isophthalic acid, phthalic acid, 2,6-naphthalenedicarboxylic acid and 4,4-diphenyldicarboxylic acid, and mixtures thereof. Preferably, the aromatic dicarboxylic acid comprises terephthalic acid, more preferably consists for at least 50 mole %, still more preferably at least 90 mole %, or even fully consists of terephthalic acid, relative to the total molar amount of dicarboxylic acid.

The alkylene diol in the hard segments of the polyetherester elastomer suitably is selected from the group consisting of ethylene glycol, propylene glycol, butylene glycol, 1,2-hexane diol, 1,6-hexamethylene diol, 1,4-butane diol, benzene dimethanol, cyclohexane diol, cyclohexane dimethanol, and mixtures thereof. Preferably, the alkylene diol comprises ethylene glycol and/or 1,4 butane diol, more preferably consists for at least 50 mole %, still more preferably at least 90 mole %, or even fully consists of ethylene glycol and/or 1,4 butane diol, relative to the total molar amount of alkylene diol.

The hard segments of the polyetherester elastomer most preferably comprise or even consist of polybutylene terephthalate segments.

Suitably, the polyalkylene oxide glycol is a homopolymer or copolymer on the basis of oxiranes, oxetanes and/or oxolanes. Examples of suitable oxiranes, where upon the polyalkylene oxide glycol may be based, are ethylene oxide and propylene oxide. The corresponding polyalkylene oxide glycol homopolymers are known by the names polyethylene glycol, polyethylene oxide, or polyethylene oxide glycol (also abbreviated as PEG or PEO), and polypropylene glycol, polypropylene oxide or polypropylene oxide glycol (also abbreviated as PPG or PPO), respectively. An example of a suitable oxetane, where upon the polyalkylene oxide glycol may be based, is 1,3-propanediol. The corresponding polyalkylene oxide glycol homopolymer is known by the name of poly(trimethylene)glycol. An example of a suitable oxolane, where upon the polyalkylene oxide glycol may be based, is tetrahydrofuran. The corresponding polyalkylene oxide glycol homopolymer is known by the name of poly(tretramethylene)glycol (PTMG) or polytetrahydrofuran (PTHF). The polyalkylene oxide glycol copolymer can be random copolymers, block copolymers or mixed structures thereof. Suitable copolymers are, for example, ethylene oxide/polypropylene oxide block-copolymers, (or EO/PO block copolymer), in particular ethylene-oxide-terminated polypropylene oxide glycol.

The polyalkylene oxide can also be based on the etherification product of alkylene diols or mixtures of alkylene diols or low molecular weight poly alkylene oxide glycol or mixtures of the aforementioned glycols.

A further example of a copolyester elastomer is a copolyester elastomer comprising monomer units of dimerised fatty acids or derivatives thereof.

The dimerised fatty acids may be obtained from monomeric unsaturated fatty acids by an oligomerisation reaction. The oligomer mixture is further processed, for example by distillation, to yield a mixture having a high content of the dimerised fatty acid. The double bonds in the dimerised fatty acid may be saturated by catalytic hydrogenation. The term dimerised fatty acid as it is used here relates to both types of these dimerised fatty acids, the saturated and the unsaturated. It is preferred that the dimerised fatty acids are saturated.

It is also possible that the thermoplastic elastomer copolymer contains monomer units of derivatives of dimerised fatty acid. For example a dimerised fatty diol may be obtained as a derivative of the dimerised fatty acid by hydrogenation of the carboxylic acid groups of the dimerised fatty acid, or of an ester group made thereof. Further derivatives may be obtained by converting the carboxylic acid groups, or the ester groups made thereof, into an amide group, a nitril group, an amine group or an isocyanate group.

The dimerised fatty acids may contain from 32 up to 44 carbon atoms. Preferably the dimerised fatty acid contains 36 carbon atoms.

Further details relating to the structure and the properties of the dimerised fatty acids may be found in the corresponding leaflet “Pripol C36-Dimer acid” of the company UNICHEMA (Emmerich, Germany) or in the brochure of the Company COGNIS (Düsseldorf, Germany) “Empol Dimer and Poly-basic Acids; Technical Bulletin 114C (1997)”.

Preferably a copolyester elastomer is used that contains monomer units of dimerised fatty acids or derivatives or soft blocks of polytetramethylene glycol.

In the production of the copolyetser elastomer the dimerised fatty acid can be used as a monomer or as a pre-cursor oligomer or polymer. In one example the pre-cursor polymer is a polyester, formed of dimerised fatty acid and/or dimerised fatty diol with any combination of diols or dicarboxylic acids. In another example the pre-cursor polymer is a polyamide, formed of dimerised fatty acid and/or dimerised fatty diamines with any combination of diamines or dicarboxylic acids forming polyamides. It is also possible that the pre-cursor polymer is a polyester-amide.

### Epoxydized Plasticizer

Examples of epoxidized plasticizers include epoxidized polybutadiene, epoxydized polybutadiene block copolymers, epoxidized vegetable oils, epoxidized modified vegetable oils, such as for example oils of esterified epoxidized fatty acids.

In principle all known epoxidized esterified fatty acids may be used, like for example fatty acid esters of ethanol, 2-ethylhexanol, esters of fatty esters of diols, like for example ethylene glycol and butylene glycol or the esters of multi-functional alcohols, like for example trimethylol propane and pentaerytritol.

Preferably epoxidized vegetable oils are used, more preferably epoxidized linseed oil or tall oil are used, most preferably epoxidized soybean oil or epoxydized octyl tallate are used.

Good results are obtained if the epoxidized plasticizer contains between 0.1 and 15 wt. % of oxyrane oxygen, preferably between 1 and 10 wt. %, more preferably between 2 and 8 wt. %.

Epoxidized vegetable oils and modified oils may be obtained by oxidizing vegetable oils and modified vegetable oils with peroxide acids.

Good results are obtained if the composition contains 1-30 wt. % o the plasticizer. Preferably the polymer compositions contains at least 3, more preferably at least 6, even more preferably at least 9, even more preferably at least 12 wt. % plasticizer. Preferably the polymer composition contains at most 25 wt. % plasticizer, more preferably at most 20 wt. %.

### SEBS

Preferably the polymer composition of the cover for a tablet, a mobile phone or a laptop bottom and the watch strap of the present invention contains a styrene-ethylene-butylene-styrene copolymer (SEBS). This is because the soft touch and the flexibility have been improved. The polymer composition may contain at least 1 wt. % of the SEBS, preferably at least 2 wt. %, more preferably at least 4 wt. %, even more preferably at least 6 wt. %.

The polymer composition may contain at most 18 wt. % SEBS, preferably at most 16 wt. % more preferably at most 14 wt. %.

### Silicon Gum

Even more preferably the composition contains a silicon gum, preferably polydimethyl siloxane. Because of this not only the soft touch and the flexibility have been improved, but also the scratch resistance. The polymer composition may contain at least 1 wt. % of the silicon gum, preferably at least 2 wt. %, more preferably at least 4 wt. %, even more preferably at least 6 wt. %.

The polymer composition may contain at most 18 wt. % silicon gum, preferably at most 16 wt. % more preferably at most 14 wt.

If the polymer composition contains both the SEBS and the silicon gum, the wt. % of the components together are preferably the same as those for the single SEBS or silicon gum.

The polymer composition may contain one or more additives.

Suitable additives include stabilizers, such as antioxidants, UV-absorbers and heat stabilizers, impact modifiers, lubricants, emulsifiers, nucleating agents, fillers, pigments, optical brighteners, further flame retardants, and antistatic agents. Suitable fillers are, for example, calcium carbonate, silicates, talcum, and carbon black.

In a preferred embodiment of the invention the polymer composition contains one or more additives in a total amount of 0.01-20 wt. %, more preferably 0.1-10 wt. %, still more preferably 0.2-5 wt. %, or even 0.5-2 wt. % relative to the total weight of the polymer composition.

Preferably the polymer composition consists of the thermoplastic elastomer, the SEBS and/or the silicon gum and the one or more additives.

Best results are obtained with a watch strap.

The invention will further be explained by the examples.

### Materials Used.

TPE-1: thermoplastic copolyether ester comprising polybutylene hard blocks and 70 wt. % polytetrahydrofuran (pTHF) soft blocks having a number average molecular weight of 2000 kg/kmol.
TPE-2: thermoplastic copolyether ester comprising polybutylene hard blocks and 82 wt. % polytetrahydrofuran (pTHF) soft blocks having a number average molecular weight of 3000 kg/kmol.
ESO: epoxidized soil bean oil.
Squalene, >98%, delivered by Aldrich.
Oleic acid, tech, 90%, delivered by Aldrich.

### Testing.

Tensile bars were produced by injection molding according to the standard ISO-527-1BA.
The bars were immersed during 72 hours at 65° C. in squalene and in oleic acid, both main components in sebum.
After 72 hours the weight increase of the bars was determined, representing the take-up of squalene respectively oleic acid.
The relative mass uptake is calculated according to:
M % uptake=(m₁−m₀)/m₀×100%, whereby m₀ is the mass of the bar before immersion and m₁ is the mass of the bar after immersion.

### Comparative Experiment A and B.

Bars of TPE-1 and TPE-2 were produced and tested as described above. The results are given in table 1.

### Experiment I.

Bars of a composition comprising 81 wt. % TPE-1 and 19 wt. % of the ESO were produced and tested as described above. The results are given in table 1.

TABLE 1

| Comp. Exp./ | | |
|---|---|---|
| Example. | Squalene % | oleic acid %. |
| A | 18.6 | 82.3 |
| B | 43.1 | 321.9 |
| I | 7.2 | 43.1 |

TPE-2 of Comparative Experiment B has a higher amount of soft blocks than TPE-1 of Comparative Experiment A. Therefore the hardness of TPE-2 is lower than the hardness of TPE-1. From the comparison between comparative experiments A and B in table 1 it is clear that the take up of both squalene and oleic acid increases a lot by increasing the amount of the soft blocks
The take up of the composition of example I is not only lower than that of TPE-1 (comparative experiment A), but is even very much lower than that of TPE-2 in Comparative Experiment B. The last comparison is important, since the polymer of Comparative Experiment B has the same hardness and flexibility as the composition of Example I.
The hardness and flexibility is an important property for watch straps etc.

1. A cover for a tablet, a mobile phone or a laptop bottom and a watch strap, consisting at least partly of a polymer composition containing:
(A) a thermoplastic elastomer, and
(B) 1-30 wt. % of an epoxydized plasticizer

2. A cover for a tablet, a mobile phone or a laptop bottom and a watch strap according to claim 1, wherein the polymer composition comprises at least 3 wt. % of the plasticizer.

3. A cover for a tablet, a mobile phone or a laptop bottom and a watch strap according to claim 1, wherein the polymer composition contains at least 6 wt. % of plasticizer.

4. A cover for a tablet, a mobile phone or a laptop bottom and a watch strap according to claim 1, wherein the polymer composition contains a styrene-ethylene-butylene-styrene copolymer (SEBS).

5. A cover for a tablet, a mobile phone or a laptop bottom and a watch strap according to claim 4, wherein the polymer composition contains 1-18 wt. % of the SEBS.

6. A cover for a tablet, a mobile phone or a laptop bottom and a watch strap according to claim 1, wherein the polymer composition contains a silicon gum.

7. A cover for a tablet, a mobile phone or a laptop bottom and a watch strap according to claim 6, wherein the polymer composition contains 1-18 wt. % of the silicon gum.

8. A cover for a tablet, a mobile phone or a laptop bottom and a watch strap according to claim 1, wherein the polymer composition contains SEBS and silicon gum in a quantity added up of 1-18 wt. %.

9. A cover for a tablet, a mobile phone or a laptop bottom and a watch strap according to claim 1, wherein the composition contains 0.01-20 wt. % of one or more additives.

10. A watch strap consisting at least partly of a polymer composition as defined according to claim 1.
